(19) United States
(12) Patent Application Publication
(10) Pub. No.: US 2024/0025101 A1
(43) Pub. Date: Jan. 25, 2024

(54) CROSS-LINKED POLYARYLETHERKETONES

(71) Applicant: Freudenberg SE, Weinheim (DE)

(72) Inventors: Thomas SCHAUBER, Weinheim (DE); Marco SUTTER, Weinheim (DE); Kira TRUXIUS, Darmstadt (DE)

(21) Appl. No.: 18/257,338

(22) PCT Filed: Oct. 28, 2021
(86) PCT No.: PCT/EP2021/080005

§ 371 Date: Jun. 14, 2023

(30) Foreign Application Priority Data
Dec. 18, 2020 (DE) 10 2020 134 149.0
Jul. 27, 2021 (DE) 10 2021 119 437.7

(51) Int. Cl. B29C 48/00; B29C 48/40; C08G 65/40; C08L 77/06; C08K 5/17

(52) U.S. Cl. CPC B29C 48/022; B29C 48/40; C08G 65/4012; C08L 77/06; C08K 5/175; C08G 2650/20; C08G 2650/40; C08L 2203/30; C08L 2312/00; B29K 2071/00

(57) ABSTRACT

A moulding including a matrix obtained from a reaction of a polyaryletherketone (PAEK) with at least one crosslinker capable of thermal crosslinking with keto groups of the PAEK to form at least two imine groups per crosslinker molecule. The crosslinker is selected from oligomers/polymers which have at least two amide groups or at least one amide group and at least one primary amino group or at least two imide groups or at least one imide group and at least one primary amino group, saturated alicyclic compounds which are different from the oligomers/polymers and have at least two primary amino groups, and mixtures thereof.

### CROSS REFERENCE TO RELATED APPLICATIONS

This application is a U.S. National Phase application under 35 U.S.C. § 371 of International Application No. PCT/EP2021/080005, filed on Oct. 28, 2021, and claims benefit to German Patent Application No. DE 10 2020 134 149.0, filed on Dec. 18, 2020, and to German Patent Application No. DE 10 2021 119 437.7, filed on Jul. 27, 2021. The International Application was published in German on Jun. 23, 2022 as WO 2022/128224 A1 under PCT Article 21(2).

### FIELD

The present invention relates to a moulding which comprises a polymer matrix containing a crosslinked polyaryletherketone, and also to a process for producing such a moulding. The invention further relates to sealing articles, thrust washers, back-up rings, valves, connectors, insulators, snap hooks, bearings, bushes, films, powders, coatings, fibres, sealing rings and O-rings, tubes and conduits, cables, sheaths and jackets, and also housings of an electrical or chemical application, which comprise such a moulding or which consist of such a moulding.

### BACKGROUND

Thermoplastically processible plastics (thermoplastics) have become widespread by virtue of the productivity of their manufacture, the reversible deformability and often also because of their high-grade technical properties, and are nowadays a standard product in industrial production. They consist of substantially linear polymer chains, meaning that they are not crosslinked and in general also have little or no branching. Thermoplastics, however, have an intrinsic limit to their temperature stability and are therefore not ideally suited to all sectors where polymeric materials are used. It is therefore desirable to raise the temperature stability of thermoplastics without losing advantages, such as good mechanical properties or high chemical resistance, for example. An advantage here is possessed often by crosslinked polymers (thermosets) in which the macromolecules are joined to one another by covalent bonds. These polymers at low temperatures are in a hard-elastic state, also referred to as the glass state. Where thermosets are heated beyond this range, they generally enter directly into the realm of thermal decomposition.

Polyaryletherketones (PAEK), for example polyetheretherketones (PEEK), are semicrystalline thermoplastics which have high temperature stability and high media resistance and which belong to the group known as engineering polymers. They have an alternating construction in which each aryl group is followed by a keto group (carbonyl group) or ether group, where the fractions of the ketone and ether groups are variable and may differ in the substitution pattern on the aryl rings. These two factors substantially determine the properties of the PAEK polymers. PAEK polymers are notable specifically for good strength properties even at relatively high temperatures, for high impact strengths at low temperatures, for high mechanical cycling resistance, for low propensity towards creep deformation, and for good sliding and wear behaviour. The long-term service temperatures are up to about 260° C. and the short-term maximum deployment limits reach close to the melting point (around 373° C. for PEK and around 340° C. for PEEK). Their uses include high-performance mouldings and also, especially, seals and back-up rings in the oil and gas transport sector. Here as well, PAEK polymers are notable for their toughness and chemical resistance, and consequently the material has so far not been replaced by any other class of material. However, the PAEK and especially PEEK polymers as well have the aforementioned intrinsic limit on temperature stability, as is typical for thermoplastics. To raise further the temperature stability and the mechanical stability of the PAEK polymers, proposals have been made to crosslink the polymer chains. For crosslinking, the prior art uses processes in which the PAEK polymers are crosslinked with diamines. This entails formation of imine bonds (Schiff bases) which are able to provide the crosslinked polymers with relatively high stability. A disadvantage here is that these crosslinked polymers are not flowable. They can therefore not readily be processed thermoplastically from a melt of the polymer. A further disadvantage is that not every diamine suitable in principle as a crosslinker can actually also be used. In particular, amines which are volatile even at low temperatures pose a risk to the user and also lead to a considerable environmental burden.

The process for the chemical crosslinking of polyetheretherketones (PEEK) with diamines has been known since the 1980s. It involves first modifying polyetheretherketone, in diphenyl sulfone as solvent, by attachment of para-phenylenediamine. It is then necessary for the solvent to be removed by drying and further purification. A problem is that in the process described, and also in the covalent attachment, crosslinks are already being formed. While this is accompanied by a rise in the temperature stability, there is also an increase in the glass transition temperature, and the possibility of thermoplastic processing is lost. The resulting polymer material is therefore crosslinked not thermoplastically from the melt, but instead by compression moulding.

It is also known practice to modify the PEEK first by analogous reaction of PEEK and phenylenediamine in diphenyl sulfone as solvent, and to carry out crosslinking, following removal of the solvent and purification, by compression moulding. Thermoplastic processing is likewise not described. The study shows that the products have a higher stability than non-crosslinked PEEK, but are still in need of improvement in their stability. In this process in solution, in particular, the crystallinity is almost completely lost, and consequently the elasticity modulus is low by comparison with thermoplastic PEEK at temperatures above the glass state.

WO 2010/011725 A2 describes a multiplicity of aminic crosslinkers for crosslinking PAEK. The document, however, contains only a single synthesis example, which describes the crosslinking of PAEK with phenylenediamine in accordance with the references cited above, starting with a reaction in diphenyl sulfone as solvent.

A process for the crosslinking of PAEK with non-aminic crosslinkers is proposed in U.S. Pat. No. 6,887,408 B2.

For the crosslinking of PAEK there have also been proposals in the prior art for the polymers themselves to be functionalized with crosslinkable amino groups. Processes of this kind are described in US 2017/0107323 A1, for example. A disadvantage here is that the functionalization of the PAEK with amino groups is relatively complicated. Moreover, the crosslinking of functionalized PAEK cannot be controlled so simply and flexibly as with a low molecular mass crosslinker.

WO 2020/056052 describes crosslinkable polymer compositions comprising at least one aromatic polymer and at least one crosslinking compound which is capable of crosslinking the at least one aromatic polymer. Fluorene derivatives are used as crosslinking compounds.

The processes described in the prior art for the crosslinking of PAEK with diamines as low molecular mass crosslinkers are carried out in the presence of a high fraction of solvent, with the mouldings being produced by compression moulding. The products are more temperature-stable than comparable non-crosslinked PAEK polymers. A disadvantage, however, is that PAEK crosslinked in this way has a relatively low stiffness, owing to the loss of crystallinity by the PAEK when the polymers are dissolved in the solvent. In the course of further processing, no more than a small proportion of the crystallinity can be regained, owing to the intrinsic steric hindrance of the chains as a result of the crosslinking points. A further disadvantage is that the processes overall are very complicated, since they require a multiplicity of individual operations, not least because of the removal of the solvent. A further disadvantage is that the mouldings are produced by compression moulding, thereby limiting the possible applications by comparison with thermoplastic processing. Compression moulding and comparable processes are carried out with non-flowable materials, which cannot be converted into thermoplastic melts. This limits deformability, and it is impossible to produce thin-walled or complex mouldings. For these reasons there are also severe limits on the possibility for automation of such processes. On the basis of the known, solvent-based processes, therefore, there can be no efficient and inexpensive industrial production.

WO 2010/011725 A2 describes very generally the production of mouldings from crosslinked PAEK by extrusion. This, however, is only a theoretical proposal, as products are produced only on the laboratory scale and by compression moulding. There is no proof that the PAEK polymers crosslinked with low molecular mass crosslinkers are extrudable, let alone that they can lead to products having advantageous properties. Nor, for a skilled person, is there any reasonable prospect of success in being able to plastify PAEK and amino-containing crosslinkers in an extruder and then subject them to a shaping step. A first problem is that at the high melting temperatures required, at which the components must be mixed and processed, crosslinking already begins. Secondly, there was no expectation that PAEK would be able to be mixed and processed with such aminic crosslinkers in the absence of a solvent. In practice, when low molecular mass components are incorporated into polymers, processes of separation are a frequent observation. The uniform distribution of the crosslinker in the polymer, however, is vital to the acquisition of a stable product.

WO 2020/030599 A2 describes a process for producing a PAEK-containing crosslinked moulding, where the crosslinker is a di(aminophenyl) compound in which the two aminophenyl rings are joined to one another via an aliphatic group which contains a carbocyclic radical. Employed specifically as crosslinker component is 1-(4-aminophenyl)-1,3,3-trimethylindan-5-amine, DAPI (CAS No. 54628-89-6), or the isomer mixture (CAS No. 68170-20-7). A first disadvantage are the high costs of producing the crosslinker. A second are the physicochemical properties of the PAEK crosslinked with DAPI, which are deserving of improvement.

US 2020/0172669 and US 2020/0172667 describe crosslinkable polymer compositions comprising at least one aromatic polymer and at least one crosslinking compound which is capable of crosslinking the aromatic polymer. Crosslinking compounds used comprise derivatives of fluorenes, diphenylmethanes and dihydroanthracenes.

### SUMMARY

In an embodiment, the present disclosure provides a moulding comprising a matrix obtained from a reaction of a polyaryletherketone (PAEK) with at least one crosslinker capable of thermal crosslinking with keto groups of the PAEK to form at least two imine groups per crosslinker molecule. The crosslinker is selected from oligomers/polymers which have at least two amide groups or at least one amide group and at least one primary amino group or at least two imide groups or at least one imide group and at least one primary amino group, saturated alicyclic compounds which are different from the oligomers/polymers and have at least two primary amino groups, and mixtures thereof.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows the development of the complex dynamic modulus with increasing temperature of the mouldings of an embodiment of the invention in comparison to various reference materials used in similar fields.

FIG. 2a shows specimens comprising crosslinked and non-crosslinked PEEK;

FIG. 2b shows specimens comprising crosslinked and non-crosslinked PEEK after two-week storage in sulfuric acid;

FIGS. 3a, 3b, 3c, 3d, and 3e show the test results for a rheological study.

### DETAILED DESCRIPTION

In an embodiment, the present invention provides processes and products which overcome the disadvantages described above.

An embodiment of the present invention provides materials based on PAEK which have a high stability and good processing properties. The materials are, in particular, to have high temperature stability and high stiffness (modulus) at high temperatures. They are also to possess high resistance towards chemicals, and a low combustibility. The materials, moreover, are to have low creeping propensity and a rubber-elastic behaviour in the high-temperature range.

An embodiment of the invention in particular provides materials which have high stability but are nevertheless easy to process. These materials are to be amenable to simple, efficient and inexpensive production. Here it would be a particular advantage for the materials to be thermoplastically processible and to be able to be crosslinked in a targeted way only after shaping. A particular intention here is to avoid inefficient processes, such as compression moulding.

The processes are also to be extremely eco-friendly and to involve no risk to users in their implementation.

Surprisingly, the advantages described herein are achieved by means of processes, mouldings and sealing articles where a polyaryletherketone undergoes crosslinking with a specific diamine source, with formation of imine groups. Here it is possible first to subject a plastified mixture of polyaryletherketone and diamine source to a shaping process for the purpose of producing a moulding. Subsequently the moulding can then be subjected to crosslinking. These two steps may in part also be combined in one step in the injection moulding machine.

An embodiment of the invention provides a moulding comprising a matrix obtainable from the reaction of a polyaryletherketone (PAEK) with at least one crosslinker capable of thermal crosslinking with the keto groups of the PAEK to form at least two imine groups per crosslinker molecule, the crosslinker being selected from
a) oligomers/polymers which have at least two amide groups or at least one amide group and at least one primary amino group or at least two imide groups or at least one imide group and at least one primary amino group,
b) saturated alicyclic compounds which are different from a) and have at least two primary amino groups, and mixtures thereof.

One preferred embodiment is a moulding comprising a matrix obtainable from the reaction of a polyaryletherketone with at least one crosslinker selected from polyamides, polyimides, aminated dimer fatty acids, oligomers/polymers comprising aminated dimer fatty acids in copolymerized form, and mixtures thereof.

It will be appreciated that PAEK may also be present in the form of a polymer blend/polymer mixtures. Suitable mixture partners are selected from engineering plastics (high-performance thermoplastics), selected more particularly from polyphenylene sulfides (PPS), polyamideimides (PAI), polyphthalamides (PPA), polysulfones (PSU), thermoplastic polyimides (TPI), polyethersulfones (PES or PESU), polyphenylene ethers (PPE), polyphenylene sulfones (PPSU) and liquid-crystalline polymers (LCP).

An embodiment of the invention provides a moulding in the form of a coating.

An embodiment of the invention provides a process for producing a moulding, comprising the steps of
i) providing a mixture comprising at least one polyaryletherketone and at least one crosslinker selected from
   a) oligomers/polymers which have at least two amide groups or at least one amide group and at least one primary amino group or at least two imide groups or at least one imide group and at least one primary amino group,
   b) saturated alicyclic compounds which are different from a) and have at least two primary amino groups,
   and mixtures thereof,
ii) producing a moulding from the mixture obtained in step i), and
iii) thermally treating the moulding at a temperature at which the polyaryletherketone is crosslinked.

An embodiment of the invention provides mouldings obtained by this process.

An embodiment of the invention provides a polymer mixture comprising at least one polyaryletherketone (PAEK) and at least one crosslinker, as defined above and below. Concerning suitable and preferred PAEK polymers and crosslinkers contained in the polymer mixture, reference is made in full to the following observations in the context of the mouldings of embodiments of the invention and their production.

An embodiment of the invention provides a moulding precursor obtainable by a process comprising steps i) and ii), as defined above and below.

An embodiment of the invention provides for the use of a moulding, as defined above and below, or obtainable by a process, as defined above and below, in the sectors of motor vehicles, shipping, aerospace, rail vehicles, oil and gas industry, food and packaging industry and medical devices.

An embodiment of the invention provides sealing articles, thrust washers, back-up rings, valves, connectors, insulators, snap hooks, bearings, bushes, films, powders, coatings, fibres, sealing rings and O-rings, tubes and conduits, cables, sheaths and jackets, housings of an electrical or chemical application, which consist of a moulding of embodiments of the invention or a moulding obtained by the process of embodiments of the invention, or which comprise such a moulding.

### DESCRIPTION OF THE INVENTION

The polymer composition of embodiments of the invention, the moulding of embodiments of the invention and also the process of embodiments of the invention have the following advantages:
The process of embodiments of the invention for producing the mouldings based on crosslinked PAEK avoids substances, such as volatile aromatic amines, which pose a potential hazard to environment and health.
The mouldings of embodiments of the invention and the crosslinked polyaryletherketones used in embodiments of the invention are notable for high temperature stability and for a higher maximum usage temperature than non-crosslinked PAEK polymers. They have a high glass transition range, more particularly a higher glass transition range by comparison with DAPI-crosslinked polyaryletherketones.
The crosslinked polyaryletherketones used in embodiments of the invention and the mouldings of embodiments of the invention exhibit a high level of the rubbery plateau in dynamic mechanical analysis (DMA), more particularly a rubbery plateau level higher by about one decade, above the melting range, in comparison to DAPI-crosslinked polyaryletherketones.
The process of embodiments of the invention features low costs, more particularly lower costs by comparison with PAEK crosslinking using DAPI and other aromatic diamines. The diamine sources used in embodiments of the invention are commercially available raw materials with generally low acquisition costs.
The polyamides can serve as a source of low molecular mass polyamides and diamines. Depending on reaction conditions it is possible to regulate which crosslinker component is formed from the polyamides. By using polyamides as diamine source, therefore, PAEKs as well can be crosslinked using low-boiling aliphatic diamines, which would otherwise be impossible or very complicated to react with the PAEKs for reasons of process engineering/safety technology/environmental technology.
The process of embodiments of the invention is simple to implement technically, requiring the conveying and mixing of only two components (pellets).
The polymer composition of embodiments of the invention or the moulding of embodiments of the invention has very good tribological properties. They are suitable for materials for use under abrasive wear conditions, for example as seals and friction bearing materials in conveying installations for aggressive and abrasive media.
The polymer composition of embodiments of the invention and the moulding of embodiments of the invention exhibit relatively low swelling, particularly by comparison with DAPI-crosslinked polyaryletherketones.
Because of the long-established components used, there is no need for a REACH application for the polymers.
The process of embodiments of the invention is sustainable. The uncrosslinked residual substances can be recycled easily and effectively and do not need to be passed on for disposal.

### Polyaryletherketone

In polyaryletherketones (PAEK) there is an aryl group linked respectively in (1,4 and/or 1,3)-position between the functional groups. The polyaryletherketones have a rigid, semicrystalline structure that gives the materials comparatively high glass transition temperatures and melting temperatures.

The polymer component used may comprise in principle any desired polyaryletherketones. Polyaryletherketones are characterized by linear polymer chains of aryl, ether and keto groups. The compounds in this class differ in the differing arrangement of these groups and their proportion in the molecule. The PAEK here may be, for example, a polyetheretherketone (PEEK), a polyetherketone (PEK), a poly(etherketoneketone) (PEKK), a poly(etheretheretherketone) (PEEEK), a poly(etherketoneetherketoneketone) (PEKEKK) or a poly(etheretherketoneketone) (PEEKK). The compounds in this class have keto groups which are capable of reacting with primary amines to form imine groups (Schiff bases). Polyaryletherketones may therefore be joined covalently to one another (crosslinked) via imine bonds using diamines or diamine sources. Mixtures of different polyaryletherketones may also be used here. It is preferred for a single PAEK to be used, since this enables a high crystallinity and associated temperature stability to be achieved.

In another embodiment PAEK is used in the form of a polymer blend/polymer mixtures. Suitable mixture partners are selected from engineering plastics (high-performance thermoplastics), selected more particularly from polyphenylene sulfides (PPS), polyamideimides (PAI), polyphthalamides (PPA), polysulfones (PSU), thermoplastic polyimides (TPI), polyethersulfones (PES or PESU), polyphenylene ethers (PPE), polyphenylene sulfones (PPSU) and liquid-crystalline polymers (LCP). In one preferred embodiment the polyaryletherketone (PAEK) is a polyetheretherketone (PEEK, CAS number 29658-26-2). More preferably the polyaryletherketone (PAEK) is a polyetheretherketone (PEEK) having a melting range from 335° C. to 345° C. It has been found that PEEK crosslinked in embodiments of the invention has particularly advantageous properties in terms of temperature stability and mechanical stability.

The polyaryletherketone (PAEK) preferably has a melt viscosity at 380° C. in the range from 5 cm³/10 min to 250 cm³/10 min, more particularly from 50 cm³/10 min to 200 cm³/10 min. The measurement is made according to DIN ISO 1133, with the material being melted at 380° C. and loaded with a 5 kg piston, after which the flowability is determined. Commercially available PAEK, more particularly PEEK variants, are generally suitable. The melt viscosity correlates in general with the molecular weight of the polymer chains. It has been found that a melt viscosity of this kind is advantageous since in accordance with embodiments of the invention not only are good thermoplastic processing properties and miscibility achieved but also it is possible to obtain a homogeneous product having high stability and at the same time, in particular, high stiffness.

Suitable PAEK polymers are available commercially, examples being Vestakeep 2000 (melt volume rate, ISO 1133 (380° C./5 kg) 70 ml/10 min) and KetaSpire KT820 (melt mass flow rate, ASTM D1238 (400° C./2.16 kg) 3 g/10 min).

The crosslinker is used preferably in an amount of 0.05 wt % to 30 wt %, preferably of 0.1 wt % to 30 wt %. It is particularly preferred here for the PAEK used to be a PEEK, more particularly one having a melt viscosity as stated above. In that case the crosslinker is preferably used in an amount of 0.05 wt % to 30 wt %, preferably 0.1 wt % to 20 wt %, based on the total weight of PEEK and crosslinker. With a proportion of this kind and with these kinds of properties on the part of the starting materials, it is possible to achieve particularly good processing properties and temperature stability of the products.

In a first preferred embodiment, the oligomers/polymers are used in an amount of 0.5 wt % to 30 wt %, more particularly 1 to 10 wt %, based on the total weight of polyaryletherketone and crosslinker.

In a second preferred embodiment, saturated alicyclic compounds other than oligomers/polymers are used in an amount of 0.05 wt % to 10 wt %, more particularly 0.1 to 5 wt %, based on the total weight of polyaryletherketone and crosslinker.

In particular the stiffness is especially high, characterized by a high tensile modulus at high temperatures. Furthermore, such a PAEK, more particularly PEEK, may be processed at a temperature which still permits thermoplastic mixing with the crosslinker without the crosslinking reaction proceeding too quickly during the provision of the mixture (=step i)). The result is a plastified material which can be used very effectively in a shaping operation for producing a moulding (=step ii). The mouldings obtained in this way may subsequently be subjected to a thermal treatment (step iii) in which the ultimate materials properties are achieved through crosslinking of the PAEK.

In a further embodiment, the PAEK takes the form of a mixture with at least one further polymer. The further polymers are, more particularly, thermoplastic polymers. Preferred further polymers are selected from polyphenylene sulfides (PPS), polyamideimides (PAI), polyphthalamides (PPA), thermoplastic polyimides (TPI), polysulfones (PSU), polyethersulfones (PES or PESU), polyphenylene sulfones (PPSU), polyphenylene ethers (PPE) and liquid-crystalline polyesters (LCP) and mixtures thereof. Preferred mass ratios between PAEK and further polymers, more particularly between PAEK and further thermoplastic polymers, are 1:1 to 100:1, preferably 5:1 to 100:1, more preferably 10:1 to 100:1.

### Crosslinker

The crosslinker used for crosslinking the PAEK is preferably selected to an extent of at least 20 wt %, preferably at least 50 wt %, more preferably at least 80 wt %, more particularly at least 90 wt %, especially at least 99 wt %, based on the total weight of the crosslinker, from:
a) oligomers/polymers which have at least two amide groups or at least one amide group and at least one primary amino group or at least two imide groups or at least one imide group and at least one primary amino group,
b) saturated alicyclic compounds which are different from a) and have at least two primary amino groups, and mixtures thereof.

This applies analogously in respect of the crosslinker provided in step i) of the process of embodiments of the invention.

The amount of the crosslinker is established in relation to the desired degree of crosslinking. The fraction of the crosslinker is preferably 0.05 wt % to 30 wt %, more particularly 0.1 wt % to 30 wt %, based on the total weight of crosslinker and PAEK. In one preferred embodiment the fraction of the crosslinker is 0.1 to 10 wt %. It has been found that the stability of the product having a crosslinker fraction of this kind may be particularly advantageous. When the amount of crosslinker is established in this range, in particular, a significant improvement in the elongation at break can be achieved.

In a first preferred embodiment the crosslinker is selected from oligomers/polymers a) which have at least two amide groups or at least one amide group and at least one primary amino group or at least two imide groups or at least one imide group and at least one primary amino group.

For the purposes of embodiments of the invention, the term “oligomers/polymers” refers to a polymer molecule in which at least two monomer units (repeat units) are covalently linked. A monomer has one or else two or more polymerizable groups which are able to react with identical or complementary groups of further monomers. Thus, for example, an oligoamide/polyamide may result from the reaction of at least one dicarboxylic acid (monomer of A-A type) with at least one diamine (monomer of B-B type) or from the reaction of at least one lactam (monomer of A-B type).

In one embodiment the at least one crosslinker is an oligomer/polymer having at least two amide groups.

The term “polyamide” is used below synonymously with an oligomer/polymer which has at least two amide groups.

Where the polyamides are referred to below as crosslinkers, this term also embraces the products of lower molecular weight that are formed during the reaction in the process of embodiments of the invention (e.g. from a hydrolytic cleavage of amide groups to form amine groups capable of reacting with the keto groups of the PAEK), in so far as these products are capable of crosslinking the PAEK. Accordingly, crosslinkers used may be not only the polyamides employed for providing the mixture of polyaryletherketone and crosslinker but also any desired amino-containing oligomers and diamine monomers thereof.

The designation “polyamides” brings together, below, homopolyamides and copolyamides. To designate the polyamides, embodiments of the invention sometimes uses common technical abbreviations made up of the letters PA with following numbers and letters. Some of these abbreviations are defined in DIN EN ISO 1043-1. Polyamides which can be derived from aminocarboxylic acids of the type H₂N—(CH₂)_{z}—COOH or from the corresponding lactams are labelled PA Z, where Z denotes the number of carbon atoms in the monomer. For example, PA 6 stands for the polymer of ε-caprolactam or of ε-aminocaproic acid. Polyamides which can be derived from diamines and dicarboxylic acids of the types H₂N—(CH₂)ₓ—NH₂ and HOOC—(CH₂)_{y}—COOH are labelled PA xy, where x denotes the number of carbon atoms in the diamine and y the number of carbon atoms in the dicarboxylic acid. In order to designate copolyamides, the components are listed in the order of their proportions, separated by obliques. For example, PA 66/610 is the copolyamide of hexamethylenediamine, adipic acid and sebacic acid. For the monomers used in embodiments of the invention with an aromatic or cycloaliphatic group, the following letter codes are used: T=terephthalic acid, I=isophthalic acid, MXDA=m-xylylenediamine, IPDA=isophoronediamine, PACM=4,4′-methylenebis(cyclohexylamine), MACM=2,2′-dimethyl-4,4′-methylenebis(cyclohexylamine).

The polyamides can be described by the monomers used in their production. A polyamide-forming monomer is a monomer suitable for polyamide formation.

In one preferred embodiment the crosslinker comprises an oligomer/polymer which has at least two amide groups, where the oligomer/polymer comprises in copolymerized form polyamide-forming monomers selected from
A) unsubstituted or substituted aromatic dicarboxylic acids and derivatives of unsubstituted or substituted aromatic dicarboxylic acids,
   B) unsubstituted or substituted aromatic diamines,
   C) aliphatic or cycloaliphatic dicarboxylic acids,
   D) aliphatic or cycloaliphatic diamines,
   E) monocarboxylic acids,
   F) monoamines,
   G) at least trivalent amines,
   H) lactams,
   I) ω-amino acids, and
   K) compounds different from but co-condensable with A) to I), and mixtures of such compounds,
      with the proviso that at least one of the components A) or C) and at least one of the components B) or D) must be present.

In one preferred embodiment of the invention crosslinkers used comprise semiaromatic polyamides. This is subject to the proviso that at least one of the components A) or B) and at least one of the components C) or D) must be present. In one specific embodiment the proviso is that at least one component A) and at least one component D) must be present.

The aromatic dicarboxylic acids A) are preferably selected from respectively unsubstituted or substituted phthalic acid, terephthalic acid, isophthalic acid, naphthalenedicarboxylic acids or biphenyldicarboxylic acids and the derivatives and mixtures of the aforesaid aromatic dicarboxylic acids. Substituted aromatic dicarboxylic acids A) preferably have at least one C₁-C₄ alkyl radical. Substituted aromatic dicarboxylic acids A) more preferably have one or two C₁-C₄ alkyl radicals. These radicals are preferably selected from methyl, ethyl, n-propyl, isopropyl, n-butyl, sec-butyl and tert-butyl, more preferably methyl, ethyl and n-butyl, very preferably methyl and ethyl, and more particularly methyl. Substituted aromatic dicarboxylic acids A) may also carry further functional groups which do not disrupt the amidation, examples being 5-sulfoisophthalic acid and salts and derivatives thereof. Preferred among these is the sodium salt of dimethyl 5-sulfoisophthalate. The aromatic dicarboxylic acid A) is preferably selected from unsubstituted terephthalic acid, unsubstituted isophthalic acid, unsubstituted naphthalenedicarboxylic acids, 2-chloroterephthalic acid, 2-methylterephthalic acid, 5-methylisophthalic acid and 5-sulfoisophthalic acid. Particularly preferred for use as aromatic dicarboxylic acid A) is terephthalic acid, isophthalic acid or a mixture of terephthalic acid and isophthalic acid. The aromatic diamines B) are preferably selected from bis(4-aminophenyl)methane, 3-methylbenzidine, 2,2-bis(4-aminophenyl)propane, 1,1-bis(4-aminophenyl)cyclohexane, 1,2-diaminobenzene, 1,4-diaminobenzene, 1,4-diaminonaphthalene, 1,5-diaminonaphthalene, 1,3-diaminotoluene(s), m-xylylenediamine, N,N′-dimethyl-4,4′-biphenyldiamine, bis(4-methylaminophenyl)methane, 2,2-bis(4-methylaminophenyl)propane or mixtures thereof. A particularly preferred aromatic diamine used is m-xylylenediamine.

The aliphatic or cycloaliphatic dicarboxylic acids C) are preferably selected from oxalic acid, malonic acid, succinic acid, glutaric acid, adipic acid, pimelic acid, suberic acid, azelaic acid, sebacic acid, undecane-1,11-dicarboxylic acid, dodecane-1,12-dicarboxylic acid, maleic acid, fumaric acid or itaconic acid, cis- and trans-cyclohexane-1,2-dicarboxylic acid, cis- and trans-cyclohexane-1,3-dicarboxylic acid, cis- and trans-cyclohexane-1,4-dicarboxylic acid, cis- and trans-cyclopentane-1,2-dicarboxylic acid, cis- and trans-cyclopentane-1,3-dicarboxylic acid and mixtures thereof.

The aliphatic or cycloaliphatic diamines D) are preferably selected from ethylenediamine, propylenediamine, tetramethylenediamine, pentamethylenediamine, hexamethylenediamine, heptamethylenediamine, octamethylenediamine, nonamethylenediamine, 2-methyl-1,8-octamethylenediamine, decamethylenediamine, undecamethylenediamine, dodecamethylenediamine, 2-methylpentamethylenediamine, 2,2,4-trimethylhexamethylenediamine, 2,4,4-trimethylhexamethylenediamine, 5-methylnonamethylenediamine, 2,4-dimethyloctamethylenediamine, 5-methylnonanediamine, bis(4-aminocyclohexyl)methane, 2,2-bis(4-aminocyclohexyl)propane, 1,3-bis(aminomethyl)cyclohexane and 1,4-bisaminomethylcyclohexane, 5-amino-2,2,4-trimethyl-1-cyclopentanemethylamine, 5-amino-1,3,3-trimethylcyclohexanemethylamine (isophoronediamine), 3,3′-dimethyl-4,4′-diaminodicyclohexylmethane, [3-(amino-methyl)-2-bicyclo[2.2.1]heptanyl]methanamine, aminated dimer fatty acids and mixtures thereof.

More preferably the diamine D) is selected from hexamethylenediamine, 2-methylpentamethylenediamine, octamethylenediamine, nonamethylenediamine, decamethylenediamine, undecamethylenediamine, dodecamethylenediamine, bis(4-aminocyclohexyl)methane, 3,3′-dimethyl-4,4′-diaminodicyclohexylmethane and mixtures thereof. In one preferred embodiment of the invention the aqueous solution comprises at least one diamine D) selected from hexamethylenediamine, bis(4-aminocyclohexyl)methane (PALM), 3,3′-dimethyl-4,4′-diaminodicyclohexylmethane (MACM), isophoronediamine (IPDA) and mixtures thereof.

The monocarboxylic acids E) serve for the endcapping of the polyamide oligomers used in embodiments of the invention. Suitability is possessed in principle by all monocarboxylic acids which are capable of reacting with at least some of the available amino groups under the reaction conditions of the polyamide condensation. Suitable monocarboxylic acids E) are aliphatic monocarboxylic acids, alicyclic monocarboxylic acids and aromatic monocarboxylic acids. These include acetic acid, propionic acid, n-, iso- or tert-butyric acid, valeric acid, trimethylacetic acid, caproic acid, enanthic acid, caprylic acid, pelargonic acid, capric acid, undecanoic acid, lauric acid, tridecanoic acid, myristic acid, palmitic acid, stearic acid, pivalic acid, cyclohexanecarboxylic acid, benzoic acid, methylbenzoic acids, 1-naphthalenecarboxylic acid, 2-naphthalenecarboxylic acid, phenylacetic acid, oleic acid, ricinoleic acid, linoleic acid, linolenic acid, erucic acid, fatty acids from soybean, linseed, castor bean and sunflower, acrylic acid, methacrylic acid, tertiary saturated monocarboxylic acids (for example Versatic® acids from Royal Dutch Shell plc) and mixtures thereof.

Where unsaturated carboxylic acids or their derivatives are used as monocarboxylic acids E), it may be sensible to add commercial polymerization inhibitors to the aqueous solution. The monocarboxylic acid E) is more preferably selected from acetic acid, propionic acid, benzoic acid and mixtures thereof. In one especially preferred embodiment the aqueous solution contains exclusively acetic acid as monocarboxylic acid E). In a further especially preferred embodiment the aqueous solution contains exclusively propionic acid as monocarboxylic acid E). In a further especially preferred embodiment the aqueous solution contains exclusively benzoic acid as monocarboxylic acid E).

The monoamines F) serve here for endcapping the polyamide oligomers used in an embodiment of the invention. Suitability is possessed in principle by all monoamines which are capable of reacting with at least some of the available carboxylic acid groups under the reaction conditions of the polyamide condensation. Suitable monoamines F) are aliphatic monoamines, alicyclic monoamines and aromatic monoamines. These include methylamine, ethylamine, propylamine, butylamine, hexylamine, heptylamine, octylamine, decylamine, stearylamine, dimethylamine, diethylamine, dipropylamine, dibutylamine, cyclohexylamine, dicyclohexylamine, aniline, toluidine, diphenylamine, naphthylamine and mixtures thereof.

Suitable at least trivalent amines G) are selected from N′-(6-aminohexyl)hexane-1,6-diamine, N′-(12-aminododecyl)dodecane-1,12-diamine, N′-(6-aminohexyl)dodecane-1,12-diamine, N′-[3-(aminomethyl)-3,5,5-trimethylcyclohexyl]hexane-1,6-diamine, N′-[3-(aminomethyl)-3,5,5-trimethylcyclohexyl]dodecane-1,12-diamine, N′-[(5-amino-1,3,3-trimethylcyclohexyl)methyl]hexane-1,6-diamine, N′-[(5-amino-1,3,3-trimethylcyclohexyl)methyl]dodecane-1,12-diamine, 3-[[[3-(aminomethyl)-3,5,5-trimethylcyclohexyl]amino]methyl]-3,5,5-trimethylcyclohexaneamine, 3-[[(5-amino-1,3,3-trimethylcyclohexyl)methylamino]methyl]-3,5,5-trimethylcyclohexaneamine, 3-(aminomethyl)-N-[3-(aminomethyl)-3,5,5-trimethylcyclohexyl]-3,5,5-trimethylcyclohexaneamine. Preferably no at least trivalent amines G) are used.

Suitable lactams H) are ε-caprolactam, 2-piperidone (σ-valerolactam), 2-pyrrolidone (γ-butyrolactam), caprolactam, eonanthlactam, laurylolactam and mixtures thereof.

Suitable ω-amino acids I) are 6-aminocaproic acid, 7-aminoheptanoic acid, 11-aminoundecanoic acid, 12-aminododecanoic acid and mixtures thereof.

Suitable compounds K) different from but co-condensable with A) to I) are at least tribasic carboxylic acids, diaminocarboxylic acids, etc. Suitable compounds K) are, additionally, 4-[(Z)-N-(6-aminohexyl)-C-hydroxycarbonimidoyl]benzoic acid, 3-[(Z)-N-(6-aminohexyl)-C-hydroxycarbonimidoyl]benzoic acid, (6Z)-6-(6-aminohexylimino)-6-hydroxyhexanecarboxylic acid, 4-[(Z)-N-[(5-amino-1,3,3-trimethylcyclohexyl)methyl]-C-hydroxycarbonimidoyl]benzoic acid, 3-[(Z)-N-[(5-amino-1,3,3-trimethylcyclohexyl)methyl]-C-hydroxycarbonimidoyl]benzoic acid, 4-[(Z)-N-[3-(aminomethyl)-3,5,5-trimethylcyclohexyl]-C-hydroxycarbonimidoyl]benzoic acid, 3-[(Z)-N43-(aminomethyl)-3,5,5-trimethylcyclohexyl:1-C-hydroxycarbonimidoyl]benzoic acid and mixtures thereof.

In a preferred embodiment of the invention the crosslinker used comprises a semiaromatic or aliphatic polyamide. In that case the polyamide is preferably selected from PA 4.T, PA 5.T, PA 6.T, PA 9.T, PA 8.T, PA 10.T, PA 12.T, PA 6.1, PA 8.1, PA 9.1, PA 10.I, PA 12.1, PA 6.T/6, PA 6.T/10, PA 6.T/12, PA 6.T/6.1, PA 6.T/8.T, PA 6.T/9.T, PA 6.T/10T, PA 6.1712.T, PA 12.T/6.T, PA 6.T/6.116, PA 6.T/6.1/12, PA 6.T/6.1/6.10, PA 6.T/6.1/6.12, PA 6.T/6.6, PA 6.T/6.10, PA 6.T/6.12, PA 10.T/6, PA 10.T/11, PA 10.T/12, PA 8.T/6.T, PA 8.T/66, PA 8.T/8.I, PA 8.T/8.6, PA 8.T/6.1, PA 10.T/6.T, PA 10.T/6.6 PA 10.T/10.1_, PA 10T/10.I/6.T, PA 10.T/6.I, PA 4.T/4.1/46, PA 4.T/4.1/6.6, PA 5.T/5.1, PA 5.T/5.115.6, PA 5.T/5.I/6.6, PA 6.T/6.I/6.6, PA MXDA.6, PA 6.T/IPDA.T, PA 6.T/MACM.T, PA 6.T/PACM.T, PA 6.T/MXDA.T, PA 6.T/6.1/8.T/8.1, PA 6.T/6.1/10.T/10.1, PA 6.T/6.I/IPDA.T/IPDA.I, PA 6T/6.I/MXDA.T/MXDA.I, PA 6.T/6.I/MACM.T/MACM.I, PA 6.T/6.I/PACM.T/PACM.I, PA 6.T/10.T/IPDA.T, PA 6.T/12.T/IPDA.T, PA 6.T/10.T/PACM.T, PA 6.T/12.T/PACM.T, PA 10.T/IPDA.T, PA 12.T/IPDA.T, PA 4.6, PA 6.6, PA 6.12, PA 6.10 and copolymers and mixtures thereof. The polyamide in that case is more preferably selected from PA 4.T, PA 5.T, PA 6.T, PA 9.T, PA 10.T, PA 12.T, PA 6.1, PA 9.1, PA 10.1, PA 12.1, PA 6.T/6.I, PA 6.T/6, PA 6.T/8.T, PA 6.T/10T, PA 10.T/6.T, PA 6.T/12.T, PA 12.T/6.T PA IPDA.I, PA IPDA.T, PA 6.T/IPDA.T, PA 6.T/6.I/IPDA.T/IPDA.I, PA 6.T/10.T/I PDA.T, PA 6.T/12.T/IPDA.T, PA 6.T/10.T/PACM.T, PA 6.T/12.T/PACM.T PA 10.T/IPDA.T, PA 12.T/IPDA.T and copolymers and mixtures thereof.

Another preferred embodiment are oligoamides/polyamides a) which comprise in incorporated form at least one amine selected from saturated alicyclic compounds having at least two primary amino groups. Suitable saturated alicyclic diamines and polyamines are described below as crosslinkers b), with reference being made thereto here in full. One specific embodiment are oligoamides/polyamides a) which comprise in incorporated form at least one aminated dimer fatty acid. An even more specific embodiment are oligoamides/polyamides a) which comprise in incorporated form the compound

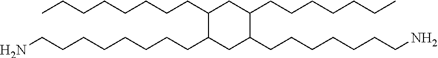 [SMILES: CCCCCCCCC1CC(CCCCCCC)C(CCCCCCCN)CC1CCCCCCCCN]

In another preferred embodiment the oligomers/polymers a) have at least two imide groups. These include, for example, polyimides selected for example from polyamideimides (PAI) and thermoplastic polyimides (TPI).

In a second preferred embodiment the crosslinker is selected from saturated alicyclic compounds b), which are different from a) and which have at least two primary amino groups. Suitable saturated alicyclic diamines and polyamines have one or more non-aromatic rings, the ring atoms being exclusively carbon atoms and the ring systems having aliphatic structure. The crosslinker b) preferably comprises at least one saturated alicyclic diamine or consists of a saturated alicyclic diamine. Preferred saturated alicyclic diamines are selected from bis(4-aminocyclohexyl)methane, 2,2-bis(4-aminocyclohexyl)propane, 1,3-bis(aminomethyl)cyclohexane and 1,4-bisaminomethylcyclohexane, 5-amino-2,2,4-trimethyl-1-cyclopentanemethylamine, 5-amino-1,3,3-trimethylcyclohexanemethylamine (isophoronediamine), 3,3′-dimethyl-4,4′-diaminodicyclohexylmethane, [3-(aminomethyl)-2-bicyclo[2.2.1]heptanyl]methaneamines, aminated dimer fatty acids and mixtures thereof.

In one preferred embodiment the saturated alicyclic compounds b) which have at least two primary amino groups are in liquid form. They may therefore serve as an internal solvent in step ii) of the process of embodiments of the invention, specifically during melt mixing. The saturated alicyclic oligomer is preferably an aminated fatty acid dimer.

The expression “fatty acid dimer” as used herein relates to the dimerized product of the reaction of two or more than two mono- or polyunsaturated fatty acids. Such fatty acid dimers are well known in the art and exist typically in the form of mixtures.

Aminated dimer fatty acids (also known as aminated dimerized fatty acids or dimer acids) are mixtures produced by oligomerization of unsaturated fatty acids. Starting materials used may be unsaturated C₁₂ to C₂₂ fatty acids. Depending on the number and position of the double bonds in the C₁₂ to C₂₂ fatty acids used for producing the dimer fatty acids, the amine groups of the dimer fatty acids are joined to one another by hydrocarbon radicals having predominantly 24 to 44 carbon atoms. These hydrocarbon radicals may be unbranched or branched and may have double bonds, C₆ cycloaliphatic hydrocarbon radicals or C₆ aromatic hydrocarbon radicals, and in these cases the cycloaliphatic radicals and/or the aromatic radicals may also be fused. The radicals which join the amine groups of the dimer fatty acids preferably have no aromatic hydrocarbon radicals, especially preferably no unsaturated bonds. Particularly preferred are dimers of C₁₈ fatty acids, i.e. fatty acid dimers having 36 carbon atoms. They are obtainable, for example, by dimerization of oleic acid, linoleic acid and linolenic acid and also of mixtures thereof. The dimerization may be followed by hydrogenation and subsequently by amination.

In one particular embodiment the saturated alicyclic oligomer is

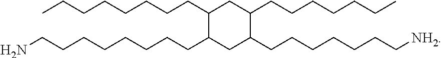 [SMILES: CCCCCCCCC1CC(CCCCCCC)C(CCCCCCCN)CC1CCCCCCCCN]

In another preferred embodiment the at least one crosslinker is a mixture comprising a polymer a) which has at least one amide group and a saturated alicyclic compound b) which has at least two primary amino groups.

It is also possible to use mixtures of two or more crosslinkers.

The process of an embodiment of the invention relates to a crosslinking reaction in which the polymer chains of the polyaryletherketones are joined to one another covalently and intermolecularly.

### Step (I)

In step (i) a mixture is provided which comprises the polyaryletherketone and the crosslinker. The mixture provided in step (i) may be produced by conventional compounding processes. In step i) preferably the at least one polyaryletherketone, the at least one crosslinker, optionally a filling and reinforcing agent and optionally at least one further additive different from the latter are subjected to melt mixing or dry mixing (compounding).

In the case of mixing in the melt, or melt mixing, the polymers are heated beyond their melting temperature and intensively mixed by rolling, kneading or extruding. The temperature in step (i) is preferably established such that the mixture has good processability and has a viscosity that is suitable for compounding. Moreover, the temperature in step (i) is preferably established such that as yet there is no substantial reaction between the polyaryletherketone and the crosslinker. An advantage here is that the aminic crosslinking of polyaryletherketone with the crosslinkers described in embodiments the invention begins only at relatively high temperatures. A prior covalent attachment of the crosslinker to the polyaryletherketone, as is described in the prior art, is unnecessary with the process of embodiments of the invention.

In one embodiment in step i) the at least one polyaryletherketone, the at least one crosslinker, optionally a filling and reinforcing agent and optionally at least one further additive different from the latter are fed into an extruder, mixed with plastification, and optionally pelletized.

In a further embodiment in step i) preferably the at least one polyaryletherketone, the at least one crosslinker, optionally at least one filling and reinforcing agent and optionally at least one further additive different from the latter are subjected to dry mixing. The stated components can be mixed using any known dry mixing technique. The product is a dry mixture (dry blend) of polyaryletherketone, the at least one crosslinker, optionally the filling and reinforcing agent and optionally at least one further additive different from the latter.

During production of the mixture, there is intensive mixing by suitable means, such as stirring or kneading equipment, to achieve a uniform distribution of the crosslinker in the polymer. This is very important for obtaining uniform stability properties in the material. The crosslinkable mixture after it has been produced is preferably processed further in step (ii) without further intermediate steps that alter the composition.

The mixing (compounding) may produce an intermediate—for example, pellets. These intermediates are stable for a relatively long time at temperatures in the range of less than 80° C., preferably of less than 50° C., especially at ambient temperature and below, and may, for example, be put into interim storage and/or transported to a different location and processed further.

In a preferred embodiment of the invention, the mixture contains no solvent. Specifically no external solvent is added to the mixture. It has surprisingly been found that mixtures of the PAEK and the crosslinker can be processed without using a solvent, with an intimate mixing taking place.

The mixture is preferably heated to a temperature at which it is in liquid or flowable (plastified) form. To obtain a homogeneous mixture it is preferred here for temperature and residence time to be selected such that there is no significant crosslinking.

In one preferred embodiment the crosslinker is added continuously to the PAEK for the purpose of producing a mixture in step i). In this case the components may be in a liquid or solid form. This allows a particularly uniform mixture to be obtained. The crosslinker in this case is added preferably with intimate mixing, with, for example, stirring, kneading, rolling and/or extruding. In one preferred embodiment the crosslinker is supplied in the form of a concentrate, for example a masterbatch in an oligomer/polymer component. An advantage of this is that the crosslinker can be metered more effectively, enabling an improvement in the uniformity of the mixture. Overall, on continuous addition of the crosslinker, a particularly homogeneous mixture can be obtained, and so the crosslinking achieved is particularly regular. This makes it possible to avoid the development of regions with different degrees of crosslinking, which can lead to inhomogeneities and possibly to damage to the product when subjected to thermal or mechanical loads. In this way, particularly good properties can be achieved in terms of temperature stability and mechanical stability.

### Step (II)

In step (ii) a moulding is produced from the mixture. The moulding production step (ii) encompasses all measures by which the mixture is brought into a three-dimensional shape which is retained in the fully cured, crosslinked state. The moulding is preferably produced by means of shaping methods of the kind customary for thermoplastics. It is preferred here for the moulding to be produced prior to crosslinking and/or during crosslinking. In general it is not critical if the mixture used in step ii) already contains low fractions of crosslinked products. Shaping takes place more preferably before step (iii), because the mixture prior to crosslinking has advantageous thermoplastic processability and shapeability, in particular by compression moulding, extruding, injection moulding and/or additive manufacturing processes.

If the components are mixed by dry mixing in step i), step ii) comprises melting the dry blend and subjecting it, as described above, to a shaping step.

In one embodiment steps i) and ii) run separately one after the other. In another embodiment steps i) and ii) run simultaneously.

In a preferred embodiment the moulding is produced in step (ii) by thermoplastic forming. This means that the mixture, in non-crosslinked form and/or at least not significantly crosslinked condition, can be shaped from the melt, since otherwise thermoplastic processing would no longer be possible. If there are too many crosslinking sites present, the PAEK intermediate is no longer flowable and no longer readily thermoplastically shapable. Prior to shaping, the mixture ought to be exposed to the high processing temperatures only for a short period. Thermoplastic processing is therefore preferably carried out such that the residence time of the mixture in the apparatus is as short as possible. It is preferred here for processing to be carried out in such a way that the major part of the crosslinking reaction takes place only after shaping, i.e. in step (iii).

In one preferred embodiment the mixture in step (ii) is processed, with accompanying forming, by extruding, compression moulding, injection moulding and/or additive manufacture. As and when required, the formed mixture before step iii) may also be reshaped. These processes are especially suitable for the simple and efficient processing of thermoplastic polymer compositions.

Extruding here may take place by known processes. On extruding (extrusion) solid to high-viscosity liquid curable compositions are extruded under pressure continuously from a shaping aperture (also called a die). This produces articles known as extrudates which have the cross section of the aperture, in theoretically any desired length. Compression moulding is a process in which the moulding composition is introduced into the preheated cavity. The cavity is then closed using a plunger. The pressure causes the moulding composition to take on the shape dictated by the mould.

Injection moulding (or the injection moulding process) is a shaping process which is used in plastics processing. It involves the plastic being plastified with an injection moulding machine and injected under pressure into a mould, the injection mould. Within the mould, cooling causes the material to return to the solid state, and after the mould is opened the material is removed in the form of a moulding. The cavity of the mould in this case determines the shape and the surface structure of the product.

Other processes for producing a moulding are the additive manufacturing processes such as, for example, fused deposition modelling (FDM), selective laser sintering (SLS), and all further processes described in the VDI 3405 directive.

Processing is accomplished more preferably by extruding and subsequent injection moulding. In the case of these processes, the mixture of the PAEK and the crosslinker is melted, if it is not in a liquid form. The mixture is introduced in step (ii) preferably into an extruder, an injection moulding machine or a compression moulding machine, melted at high temperatures, up to 450° C., for example, and brought into a desired shape.

### Step (III)

Step (iii) comprises the thermal treatment of the moulding at a temperature at which PAEK is crosslinked, so producing the crosslinked moulding. This allows the PAEK to be crosslinked intermolecularly with the crosslinker. Polyamides used as crosslinkers are hydrolysed in this process and cleaved into oligomers/diamine components. On crosslinking, two imine bonds are formed between two keto groups of the PAEK chains and the two amino groups of the diamine liberated from the crosslinker. The resulting bridge in the form of an imine is also referred to as a Schiff base, since the imine nitrogen does not carry a hydrogen item but is instead connected to an organic molecule. This crosslinking is very largely complete, and so as far as possible all the amino groups of the crosslinker used react with the carbonyl groups of the PAEK. Advantages of complete crosslinking are an increased heat distortion resistance and increased stiffness (modulus) above the glass transition temperature. In spite of this, the term “crosslinked” is also intended to embrace merely partial crosslinking. Merely partial crosslinking may exist if the amount of crosslinker used was not enough to incorporate all of the PAEK chains into the network. In that case the material generally has a higher elongation at break than the fully crosslinked material. The imine bonds give the moulding a high stability. Preferably, the moulding is a moulding based on PAEK. “Based on PAEK” here means that the PAEK is the essential structure-imparting polymer component of the moulding. In one embodiment the PAEK is preferably the only polymer component of the moulding.

The temperature in step (iii) can be set at a relatively high level, as the crosslinkers which can be used in embodiments of the invention have relatively high melting and boiling points. This is advantageous because such crosslinking reactions are generally favoured with high temperature. With preference, however, the temperature lies below the melting range of PAEK and below the softening point of the as yet not fully crosslinked moulding.

It has surprisingly emerged that in the system according to embodiments of the invention, the crosslinking reactions take place even below the melting range of the polymer and of the moulding. This was unexpected, the general assumption being that crosslinking reactions occur only at temperatures above the melting range of the polymer and of the moulding.

In embodiments of the invention, however, it has been found that the crosslinked PAEK can have particularly advantageous properties if the heating of the moulding in step (iii) is carried out preferably over a period of from at least 1 minute, for example of 6 hours, to 30 days. It has been found that the thermal stability and the mechanical stability can be substantially improved by such thermal treatment. In the case of coatings, crosslinking may be carried out at well above the melting temperature of the PAEK, meaning that very short reaction times are sufficient. In the case of solid mouldings as well, composed of a mixture with a high fibre content and/or filling content, which retain their shape if the melting range of the PAEK is exceeded, it is possible to achieve a considerable reduction in crosslinking time by means of appropriately high crosslinking temperature. With more fragile mouldings, which may warp on subsequent heating, the temperature of subsequent heating must be selected such that the moulding is still well below the melting temperature of the material, and consequently the subsequent heating times may be substantially longer, at up to 30 days.

It has been found in particular that the stiffness of the samples at elevated temperatures can be improved through the thermal treatment. The observation here was that a thermal treatment for a certain time can significantly improve the stiffness, with the subsequent possibility of saturation, so that the stiffness is not improved, or is improved only insignificantly, on further thermal aftertreatment. On further thermal aftertreatment, however, there is generally an improvement in the heat distortion resistance. It was found that the heat distortion resistance can also rise on prolonged thermal aftertreatment, allowing a significant improvement to be observed still even after a number of days.

The thermal treatment in step (iii) takes place preferably in the absence of oxygen.

After the crosslinking, the mouldings are cooled and can be passed on for use or processed further.

If desired, the moulding, during and/or after the thermal treatment in step iii), may be subjected to treatment in the presence of an oxygen-containing gas. Accordingly it is possible for the crosslinked PAEK to undergo superficial curing through targeted oxidation of the crosslinked material. For this purpose, the moulding may be subjected, for example, to subsequent heating in air after the crosslinking step, which is carried out in an inert gas atmosphere. Alternatively or additionally, a defined amount of oxygen may be metered in during the aftercrosslinking step iii).

As described above, both the mixture in step (i) and the moulding may comprise filling and reinforcing agents and/or optionally an additive different from these. The crosslinked PAEK in this case forms a matrix in which any filling and reinforcing agents and/or additives present are uniformly distributed.

Suitable filling and reinforcing agents are selected from glass fibres in the form, for example, of woven or nonwoven glass fabrics or glass mats, glass silk rovings or chopped glass silk, wollastonite, calcium carbonate, glass beads, finely ground quartz, Si nitride and boron nitride, amorphous silica, asbestos, magnesium carbonate, calcium silicate, calcium metasilicate, kaolin, mica, feldspar, talc and mixtures thereof.

Suitable additives are selected from antioxidants, UV and heat stabilizers, lubricants and mould release agents, colorants, such as dyes and pigments, nucleating agents, plasticizers and mixtures.

The filling and reinforcing agents may be used for example in an amount of up to 80 wt %, for example from 0.1 wt % to 80 wt %, especially from 1 wt % to 60 wt %, based on the total weight of the components used in producing the moulding.

The additives may be used for example in an amount of in each case up to 30 wt %, for example from 0.1 wt % to 20 wt %, based in each case on the total weight of the components used in producing the moulding.

An embodiment of the invention is a moulding based on polyaryletherketones (PAEK) which comprises a crosslinked matrix of PAEK, the PAEK being crosslinked with a diamine source as defined above. More particularly an embodiment of the invention is a moulding obtainable by the process of embodiments of the invention.

The moulding is obtained in particular by the processes of embodiments of the invention. The moulding preferably has the advantageous properties described for the crosslinked PAEK polymers. In the context of embodiments of the invention the term “moulding” denotes products of crosslinked PAEK which have a defined three-dimensional shape. There is no requirement here for the moulding to be a defined article; instead it may also be, for example, a coating. The moulding may consist of the crosslinked PAEK or may comprise it, in the form of a composite material or laminate, for example.

It may be desirable not to crosslink the polymer in the moulding completely, as the elongation at break of the material may go down with increasing crosslinking. Preferably, therefore, the degree of crosslinking is tailored to the desired application, by way of the fraction of the crosslinker and the nature and duration of the thermal treatment, for example.

The degree of crosslinking here is preferably not measured directly; instead, through suitable testing methods, such as a high-temperature tensile test and the determination of the dynamic modulus, for example, a determination is made of whether the moulding has the desired properties.

The mouldings can be used in particular in technical fields which require high temperature stability and mechanical stability, and particularly a high stiffness. They are suitable more particularly for applications as sealing articles, more particularly sealing rings and O-rings, bushes, bearings, back-up rings, valves, thrust washers, snap hooks, tubes or conduits, cables, sheaths and jackets, housings of an electrical or chemical application, or as a constituent of these. They are suitable especially for uses which require high chemical resistance and resistance to abrasion. This concerns, in particular, applications in the food and packaging industries and in medical devices, in oil and gas production, in aerospace engineering and the chemical industry, for the production there of safety-relevant components, and in the energy generation sector and the motor vehicle industry. Applications likewise conceivable are as connectors and insulators in the electronics sector, since the crosslinking results in good insulation capacity. An embodiment of the invention provides a sealing article consisting of or comprising a moulding of an embodiment of the invention. The sealing article may be useful for static or dynamic applications, and especially for dynamic applications in which it is exposed to high mechanical loads. In particular, the sealing article is suitable for sealing applications where it is in contact with fluids, such as lubricants, and where it is exposed to high temperatures, for example above 150° C., and more particularly in the range from 180° C. up to decomposition.

The processes, mouldings and sealing articles of embodiments of the invention achieve the advantages described above. They exhibit high temperature stability and high mechanical stability in conjunction with good processing properties. The mouldings in particular have a high glass transition temperature and high stiffness. The high stiffness is accompanied by reduced creep at high temperatures. The improved temperature stability is apparent not only at the maximum temperature but also at the long-term service temperature, especially in the range from 150° C. up to decomposition. The mouldings also display advantageous elastomeric behaviour in the high-temperature range. The products here exhibit very good chemical resistance and reduced combustibility, since the material, because of the crosslinking, does not melt and does not produce any drops of burning material even in the case of thin walls.

Moreover, the mouldings of embodiments of the invention can be produced in a simple and efficient way by thermoplastic shaping processes. For example, they may be produced by simple extruding. The processes, furthermore, are environmentally friendly and can be carried out without risk to users, because the crosslinkers used have relatively high boiling points and low volatility.

The intention of the examples below is to elucidate embodiments of the invention but without confining it to the embodiments specifically described.

Starting materials:
PEEK KetaSpire PEEK from Solvay
PEK Gharda PAEK 1200
PAI Polyamideimide from Solvay, brand name Torlon
TPI Polyimides, brand name Dexnyl
PPA1 PA 4,T
PPA2 PA 6,T
AA Aminated fatty acid dimer
DAPI 1-(4-aminophenyl)-1,3,3-trimethylindane-5-amine (CAS No. 54628-89-6)

### Example 1

PEEK was mixed with differing amounts of crosslinkers (see Table 1) in a twin-screw compounder and incorporated at a very low melt temperature in a short residence time. The extrudates were cooled and subsequently pelletized. The resulting pellets were subsequently dried and processed to test specimens in an injection moulding machine under very mild conditions.

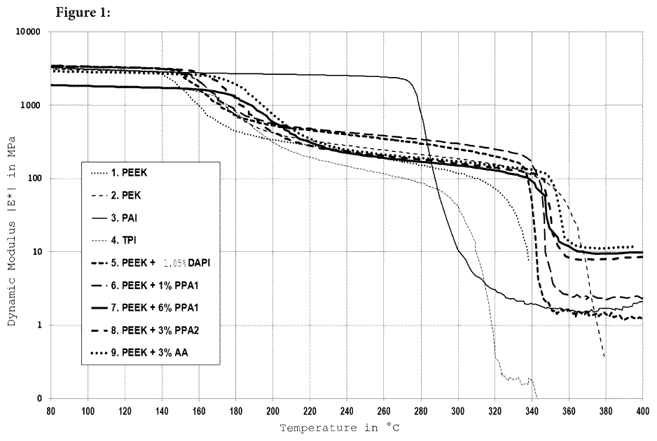

Following injection moulding, the specimens underwent subsequent thermal conditioning in an oven. From the afterheated test dumbbells of ISO Standard 527, type 1A, DMA test specimens are prepared, with dimensions of 45 mm*4 mm*2 mm. The test specimens are subsequently characterized by DMA temperature sweep (FIG. 1).

TABLE 1

| Ex. No. | Composition | Thermally conditioned |
|---|---|---|
| 1 (Comparative) | PEEK | without |
| 2 (Comparative) | PEK | without |
| 3 (Comparative) | PAI | with |
| 4 (Comparative) | TPI | without |
| 5 (Comparative) | PEEK, 1.05% DAPI | with |
| 6 | PEEK, 1% PPA1 | with |
| 7 | PEEK, 6% PPA1 | with |
| 8 | PEEK, 3% PPA2 | with |
| 9 | PEEK, 3% AA | with |

### Dynamic Mechanical Analysis (DMA)

Dynamic mechanical analysis (DMA) is a thermal method for determining physical properties of plastics. The temperature gradient (temperature sweep) shows the development of the dynamic modulus and thus likewise of the stiffness over the measured temperature range. Important factors here are, in particular, the glass transition range (Tg), the height of the plateau above the Tg, the position of the decrease in modulus on melting of the crystalline phase, and the height of the plateau in the high-temperature range.

The DMA was carried out with mouldings in accordance with the working examples described above (see Table 1). The temperature gradients were measured using specimen strips (width about 4 mm, thickness about 2 mm, sample length 45 mm, clamped-in length on testing about 20 mm) under the following conditions: heating rate 3 K/min, contact force 0.5 N, strain amplitude +/−0.1%. The results are shown in graph form in FIG. 1, which shows the development of the complex dynamic modulus with increasing temperature of the mouldings of the invention in comparison to various reference materials used in similar fields. The reference materials are the commercial thermoplastics, including Ketaspire-brand PEEK (1), PEK from Gharda Plastics (2), Torlon-brand PAI (3) and Dexnyl-brand TPI (4). A further reference shown is a PEEK crosslinked with 1.05% of DAPI (5), having been crosslinked by thermal aftertreatment as described in WO 2020/030599. The mouldings of the invention shown are samples made from Ketaspire-brand PEEK modified with 1% and 6% of PA 4,T and crosslinked (6 and 7); a sample modified with PA 6,T and crosslinked (8), and a sample of PEEK modified by means of 3% aminated fatty acid dimer and crosslinked (9). All of the samples were produced without filling, reinforcing or other additives.

The results show that the PEEK polymers crosslinked in accordance with embodiments of the invention have advantageous thermal properties. All of the mouldings of embodiments of the invention possess a significant increase in the glass transition temperature (Tg) by comparison with the unmodified PEEK. The greatest increase relative to PEEK is exhibited by the PEEK crosslinked with aminated fatty acid dimer; the PEEK samples crosslinked with PPA give a glass transition range between that of PEEK crosslinked with aminated fatty acid dimer and PEEK crosslinked with DAPI.

Between glass transition range and melting range, the samples show an increase in the height of the plateau which falls as temperatures increase, and show a more or less pronounced increase in the melting temperature range of the crystalline phase. In this range, the height of the modulus is in inverse proportion to the concentration of the crosslinking PPA.

Additionally, above the melting range of the crystalline regions, a rubbery plateau is formed which prevents the mouldings fabricated from the material from suffering plastic deformation into the decomposition range. With the mouldings of embodiments of the invention, this is markedly further increased relative to the DAPI-crosslinked PEEK, and so overall there is an even higher heat distortion resistance.

The results also show that with the combination of PPA, but also with the aminated fatty acid dimer with PEEK, optimal product properties are achievable in terms of the increase in the glass transition range, the height of the modulus and also the height of the heat distortion resistance. Accordingly it is possible to achieve significantly higher usage conditions for products produced from this material.

The thermal properties can be further considerably improved through an extension to the thermal treatment time.

Accordingly, further increases are achieved in the temperature service range relative to PAI, TPI, non-crosslinked PEEK and even relative to DAPI-crosslinked PEEK.

### Example 2

For the estimation of the crosslinking density, swelling experiments in concentrated sulfuric acid are conducted. Non-crosslinked PEEK is soluble in concentrated sulfuric acid, whereas crosslinked PEEK swells to a greater or lesser extent depending on the crosslinking density. The lower the swelling of the sample, the higher the crosslinking density. In the experiment, a sample with dimensions of about 10*4*3 mm was sawn from an injection moulded test dumbbell, and placed into a glass vessel. For each sample, 20 ml of concentrated sulfuric acid were added at room temperature and the whole was left to stand under ambient conditions. After about a week, the sample was gently shaken by hand a few times, and the result was assessed after two weeks.

Samples:
1. PEEK+1.05% DAPI
2. PEEK with 6% PPA (no thermal conditioning)
3. PEEK with 1% PPA (thermal conditioning)
4. PEEK with 3% PPA (thermal conditioning)
5. PEEK with 6% PPA (thermal conditioning)

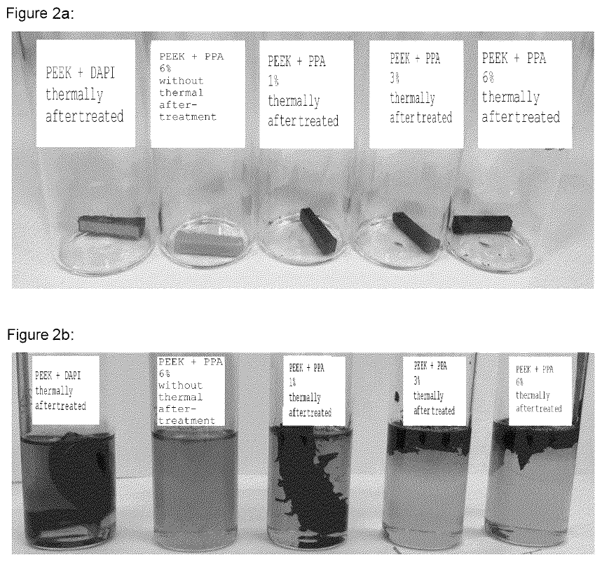

The result can be seen in FIG. 2.
1. The sample crosslinked with DAPI on the left-hand side shows a severe increase in volume due to swelling, but is not soluble.
2. The PEEK with 6% PPA in the second position, which was not thermally aftertreated, has gone completely into solution, indicating that at this point there is no crosslinking.
3. The thermally conditioned PEEK with 1% PPA exhibits significant swelling.
4. PEEK mixed with 3% PPA and thermally conditioned swells only slightly more after two weeks of storage in sulfuric acid, and this indicates a decidedly high crosslinking density.
5. PEEK mixed with 6% PPA and thermally conditioned shows hardly any further swelling, suggesting a decidedly high crosslinking density.

### Example 3

In addition to the dynamic mechanical analysis and to the swelling, rheological studies were carried out on an Anton Paar MCR-302 rheometer, showing the chemical post-crosslinking of the PAEK with the different crosslinkers. Two reference materials and three materials (PEEK, PEEK with 1.05% DAPI, PEEK with 6% PPA, PEEK with 3% PPA and PEEK with 3% AA) were processed to 2 mm test plaques by injection moulding, and the test specimens for measurement in the rheometer were prepared from these test plaques. The discs of material were placed between the plane-parallel plates of the same diameter in the rheometer, and the measuring unit was heated to the test temperature.

The test conditions are listed in Table 2.

TABLE 2

| Strain: | 0.1% | |
|---|---|---|
| Angular frequency | 10 | rad/s |
| Standard force | 0N, 2 mm | |
| Temperature | 360° | C. |

| | |
|---|---|
| Inert gas | Nitrogen |

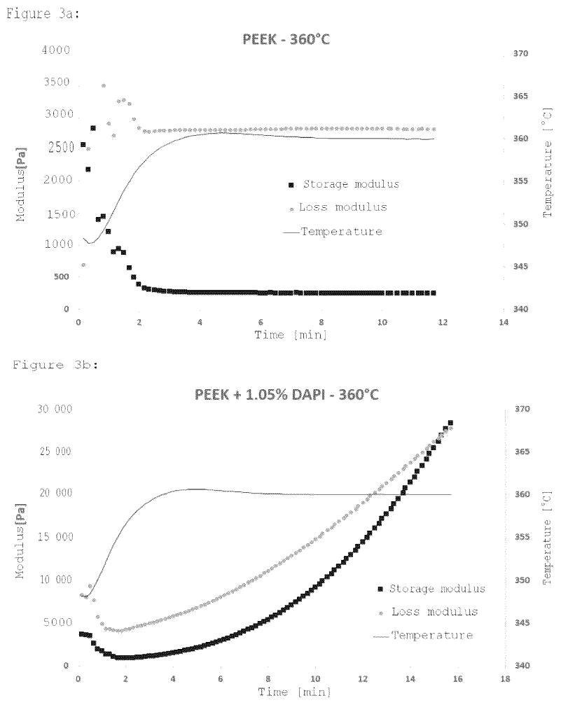

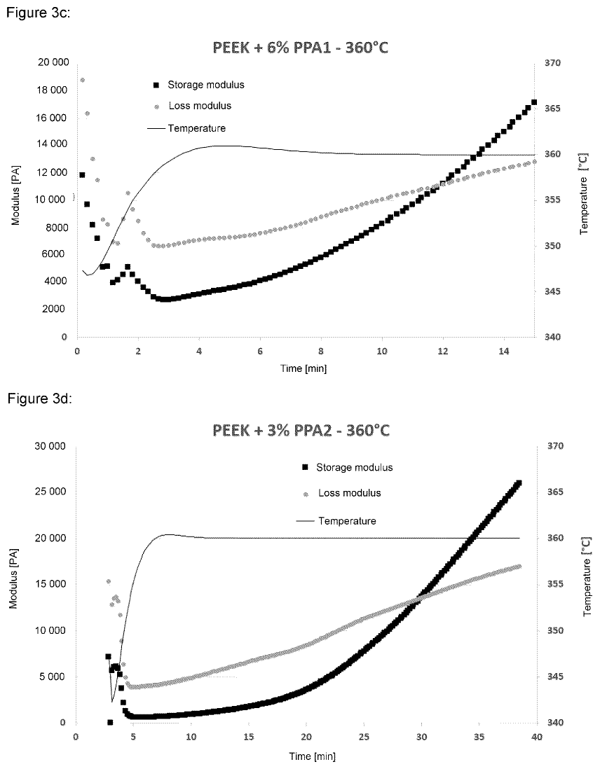

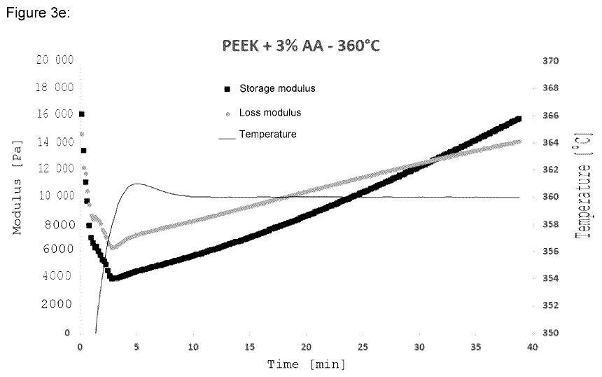

The test results are shown in FIGS. 3a to 3e. The respective storage modulus G′ (units Pa) and the respective loss modulus G″ (units Pa) of the three samples are plotted logarithmically on the Y-axis. The test time (units min) is plotted on the X-axis.

The storage modulus G′ is a measure of the mechanical energy stored on shearing of the material. The loss modulus G″ indicates the energy dissipated by the material during the shearing experiment. Liquids are unable to store any mechanical energy in a shearing experiment. Their storage modulus, accordingly, is virtually zero. In the case of viscoelastic substances, part of the energy is stored, and another part is dissipated. In the case of solids, the storage modulus G′ is generally significantly greater than the loss modulus G″.

FIG. 3a indicates the storage modulus G′ of the PEEK after a run-in phase for equilibration, at about 250 Pa. The loss modulus G″ is about 2830 Pa and remains constant over the ongoing test time. The behaviour of the non-crosslinked sample in the melt is that of a typical viscoelastic fluid.

Looking at the sample of PEEK with 1.05% DAPI in FIG. 3b, it is apparent that the storage modulus rises faster than the loss modulus, and after 15 minutes the two curves intersect, with this point defining the gel point and hence describing the transition to the solid state.

FIG. 3c shows the behaviour of PEEK after the admixture of six percent PPA. At this concentration, the gel point is reached after just about 12 minutes.

As shown in FIG. 3d, the PPA leads to crosslinking when used at three percent in PEEK about 30 minutes after the start of the melting of the sample, this crosslinking being evident from the point of intersection of the storage modulus curve with the loss modulus curve.

The use of 3% of aminated fatty acid dimer leads to an increase in storage modulus and loss modulus, following initial softening of the sample after melting, and this increase is followed by the start of crosslinking, the gel point being reached likewise after about 30 minutes, as evident from the intersection of loss modulus and storage modulus in FIG. 3e.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: A moulding comprising:
a matrix obtains from a reaction of a polyaryletherketone (PAEK) with at least one crosslinker capable of thermal crosslinking with keto groups of the PAEK to form at least two imine groups per crosslinker molecule, the crosslinker being selected from:
a) oligomers/polymers which have at least two amide groups or at least one amide group and at least one primary amino group or at least two imide groups or at least one imide group and at least one primary amino group,
b) saturated alicyclic compounds which are different from a) and have at least two primary amino groups,
and mixtures thereof.

2: The moulding according to claim 1, comprising a matrix obtainable from a reaction of a polyaryletherketone with at least one crosslinker selected from polyamides, polyimides, aminated dimer fatty acids, oligomers/polymers comprising aminated dimer fatty acids in copolymerized form, and mixtures thereof.

3: The ill-Moulding according to claim 1, which comprises at least one filling and reinforcing agent and/or at least one additive different therefrom.

4: The moulding according to claim 1, wherein the moulding is in the form of a coating.

5: A method for producing a moulding, comprising the steps of:
i) providing a mixture comprising at least one polyaryletherketone and at least one crosslinker selected from:
a) oligomers/polymers which have at least two amide groups or at least one amide group and at least one primary amino group or at least two imide groups or at least one imide group and at least one primary amino group,
b) saturated alicyclic compounds which are different from a) and have at least two primary amino groups, and
mixtures thereof,
ii) producing the moulding from the mixture obtained in step i), and
iii) thermally treating the moulding at a temperature at which the polyaryletherketone is crosslinked.

6: The method according to claim 5, wherein step i) the at least one polyaryletherketone and the at least one crosslinker are subjected to melt mixing and/or dry mixing.

7: The method according to claim 5, wherein step i) the at least one polyaryletherketone and the at least one crosslinker are fed into an extruder, mixed with plastification.

8: The method according to claim 5, wherein the crosslinker provided in step i) is selected to an extent of at least 20 wt % based on a total weight of the crosslinker, from:
a) oligomers/polymers which have at least two amide groups or at least one amide group and at least one primary amino group or at least two imide groups or at least one imide group and at least one primary amino group,
b) saturated alicyclic compounds which are different from a) and have at least two primary amino groups,
and mixtures thereof.

9: The method according to claim 5, wherein the crosslinker is an oligomer/polymer which has at least two amide groups and which comprises in copolymerized form monomers selected from:
A) unsubstituted or substituted aromatic dicarboxylic acids and derivatives of unsubstituted or substituted aromatic dicarboxylic acids,
B) unsubstituted or substituted aromatic diamines,
C) aliphatic or cycloaliphatic dicarboxylic acids,
D) aliphatic or cycloaliphatic diamines,
E) monocarboxylic acids,
F) monoamines,
G) at least trivalent amines,
H) lactams,
I) co-amino acids, and
K) compounds different from but co-condensable with A) to I), and mixtures of such compounds,
wherein at least one of the components A) or C) and at least one of the components B) or D) are included.

10: The method according to claim 5, wherein the crosslinker is an oligomer/polymer which has at least two amide groups, the oligomer/polymer comprising in copolymerized form monomers selected from unsubstituted or substituted aromatic dicarboxylic acids and derivatives of unsubstituted or substituted aromatic dicarboxylic acids and aliphatic or cycloaliphatic diamines.

11: The method according to claim 9, wherein the aromatic dicarboxylic acids are selected from respectively unsubstituted or substituted phthalic acid, terephthalic acid, isophthalic acid, naphthalenedicarboxylic acids or biphenyldicarboxylic acids and derivatives and mixtures of the aromatic dicarboxylic acids.

12: The method according to claim 9, wherein the aliphatic or cycloaliphatic diamines are selected from ethylenediamine, propylenediamine, tetramethylenediamine, pentamethylenediamine, hexamethylenediamine, heptamethylenediamine, octamethylenediamine, nonamethylenediamine, 2-methyl-1,8-octamethylenediamine, decamethylenediamine, undecamethylenediamine, dodecamethylenediamine, 2-methylpentamethylenediamine, 2,2,4-trimethylhexamethylenediamine, 2,4,4-trimethylhexamethylenediamine, 5-methylnonamethylenediamine, 2,4-dimethyloctamethylenediamine, 5-methylnonanediamine, bis(4-aminocyclohexyl)methane, 2,2-bis(4-aminocyclohexyl)propane, 1,3-bis(aminomethyl)cyclohexane and 1,4-bisaminomethylcyclohexane, 5-amino-2,2,4-trimethyl-1-cyclopentanemethylamine, 5-amino-1,3,3-trimethylcyclohexanemethylamine (isophoronediamine), 3,3′-dimethyl-4,4′-diaminodicyclohexylmethane, [3-(amino-methyl)-2-bicyclo[2.2.1]heptanyl]methanamine, aminated dimer fatty acids and mixtures thereof.

13: The method according to claim 5, wherein the crosslinker is selected from PA 4.T, PA 5.T, PA 6.T, PA 9.T, PA 8.T, PA 10.T, PA 12.T, PA 6.I, PA 8.1, PA 9.1, PA 10.I, PA 12.I, PA 6.T/6, PA 6.T/10, PA 6.T/12, PA 6.T/6.I, PA 6T/8.T, PA 6.T/9.T, PA 6.T/10.T, PA 6.T/12.T, PA 12.T/6.T, PA 6.T/6.I/6, PA 6.T/6.I/12, PA 6.T/6.1/6.10, PA 6.T/6.I/6.12, PA 6.T/6.6, PA 6.T/6.10, PA 6.T/6.12, PA 10.T/6, PA 10.T/11, PA 10.T/12, PA 8.T/6.T, PA 8.T/66, PA 8.T/8.I, PA 8.T/8.6, PA 8.T/6.I, PA 10.T/6.T, PA 10.T/6.6, PA 10.T/10.I, PA 10.T/10.I/6.T, PA 10.T/6.I, PA 4.T/4.I/46, PA 4.T/4.I/6.6, PA 5.T/5.I, PA 5.T/5.I/5.6, PA 5.T/5.I/6.6, PA 6.T/6.I/6.6, PA MXDA.6, PA 6.T/IPDA.T, PA 6.T/MACM.T, PA T/PACM.T, PA 6.T/MXDA.T, PA 6.T/6.I/8.T/8.I, PA 6.T/6.1/10.T/10.1, PA 6.T/6.I/IPDA.T/IPDA.I, PA 6.T/6.I/MXDA.T/MXDA.I, PA 6.T/6.I/MACM.T/MACM.I, PA 6.T/6.1/PACM.T/PACM.I, PA 6.T/10.T/IPDA.T, PA 6.T/12.T/IPDA.T, PA 6.T/10.T/PACM.T, PA 6.T/12.T/PACM.T, PA 10.T/IPDA.T, PA 12.T/IPDA.T, PA 4.6, PA 6.6, PA 6.12, PA 6.10 and copolymers and mixtures thereof.

14: The method according to claim 5, wherein the crosslinker is a saturated alicyclic compound which has at least two primary amino groups, selected from aminated dimer fatty acids, oligomers/polymers which comprise aminated dimer fatty acids in copolymerized form, and mixtures thereof, and the compound 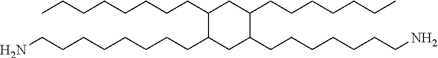 [SMILES: CCCCCCCCC1CC(CCCCCCC)C(CCCCCCCN)CC1CCCCCCCCN]
or oligomers/polymers which comprise this compound in copolymerized form.

15: The method according to claim 5, wherein the polyaryletherketone is a polyetherketone (PEK), a polyetheretherketone (PEEK) or a polyetheretheretherketone (PEEEK).

16: The method according to claim 5, wherein the mixture comprises no added solvent.

17: the method according to claim 5, wherein the temperature in step iii) is at least 300° C.

18: The method according to claim 5, wherein the mixture in step ii) is processed by extrusion, compression moulding, injection moulding and/or additive manufacturing processes.

19: The method according to claim 5, wherein during and/or after the thermal treatment in step iii) the moulding is subjected to a treatment in the presence of an oxygen-containing gas.

20: A moulding obtained by the method according to claim 5.

21: A polymer mixture comprising at least one polyaryletherketone (PAEK) and at least one crosslinker selected from:
a) oligomers/polymers which have at least two amide groups or at least one amide group and at least one primary amino group or at least two imide groups or at least one imide group and at least one primary amino group,
b) saturated alicyclic compounds which are different from a) and have at least two primary amino groups,
and mixtures thereof.

22: A moulding precursor obtained by performing steps i) and ii) of claim 5.

23: The moulding according to claim 1, wherein the moulding is configured for motor vehicles, shipping, aerospace, rail vehicles, oil and gas, food and packaging, and/or medical devices.

24: The moulding according to claim 5, wherein the moulding is part of a one or more sealing articles, thrust washers, back-up rings, valves, connectors, insulators, snap hooks, bearings, bushes, films, powders, coatings, fibres, sealing rings and O-rings, tubes and conduits, cables, sheaths and jackets, and/or housings of an electrical or chemical application.
